(19) United States
(12) Patent Application Publication
(10) Pub. No.: US 2022/0333926 A1
(43) Pub. Date: Oct. 20, 2022

(54) STAKING METHOD AND STAKING SYSTEM

(71) Applicant: Topcon Corporation, Itabashi-ku, Tokyo (JP)

(72) Inventors: Ryosuke SHIMIZU, Itabashi-ku, Tokyo (JP); Motohiro MIYAJIMA, Itabashi-ku, Tokyo (JP); Takashi TANAKA, Itabashi-ku, Tokyo (JP)

(73) Assignee: Topcon Corporation, Itabashi-ku, Tokyo (JP)

(21) Appl. No.: 17/633,199

(22) PCT Filed: Jun. 8, 2020
(86) PCT No.: PCT/JP2020/022481

§ 371 Date: Feb. 6, 2022

(30) Foreign Application Priority Data
Aug. 16, 2019 (JP) 2019-149243

(51) Int. Cl. G01C 15/06

(52) U.S. Cl. CPC G01C 15/06

(57) ABSTRACT

A method of placing a slope staking tool including pickets, crossbeams, and a slope beam. The staking method includes: placing the pickets near an intersection C between a current ground and a plane S including a designed slope s; placing the crossbeams on the pickets placed, so as to cross the pickets; searching for a point where a height difference Δh between a predetermined point on the crossbeam and the plane S including the designed slope s, calculated by a surveying device, is zero; and placing, on the crossbeams, the slope beam inclined from the point where the height difference Δh is zero as found in the search step, toward the intersection C between the current ground and the plane including the designed slope.

### TECHNICAL FIELD

The present disclosure relates to a staking method and a staking system for placing a slope staking tool showing a slope obtained by cutting or banking.

### BACKGROUND ART

In civil engineering works, there is a slope staking tool placed at a cutting start position (i.e., the top of a slope obtained by cutting) or a banking start position (i.e., the toe of a slope obtained by banking) to indicate the inclination of a slope (hereinafter referred to as a “designed slope”) finished by cutting or banking.

As described in Patent Document 1, for example, a slope staking tool includes two piles put up in the ground, a crossbeam extending horizontally across the pickets, and a slope beam extending on the crossbeam along a designed slope.

### CITATION LIST

### Patent Document

PATENT DOCUMENT 1: Japanese Unexamined Patent Publication No. 2004-238804

### SUMMARY OF THE INVENTION

### Technical Problems

There is however a need for the slope staking tool shown in Patent Document 1 to vertically erect the pickets, horizontally place the crossbeam, and perform placement in view of the shapes of the pickets, the crossbeam, and the slope beam, which requires accuracy and reduces the efficiency in the placement.

The present disclosure was made to solve the problems. It is an objective of the present disclosure to provide a staking method and a staking system that increase the efficiency in placing a slope staking tool.

### Solution to the Problems

In order to achieve the objective, a staking method according to the present disclosure is a method of placing a slope staking tool including a picket, a crossbeam, and a slope beam. The staking method includes: a picket placement step of placing the picket near an intersection between a current ground and a plane including a designed slope; a crossbeam placement step of placing the crossbeam, on the picket placed so as to cross the picket; a search step of searching for a point where a height difference between a predetermined point on the crossbeam and the plane including the designed slope is zero, the height difference being calculated by a surveying device; and a slope beam placement step of placing, on the crossbeam, the slope beam inclined from the point where the height difference is zero as found in the search step, toward the intersection between the current ground and the plane including the designed slope.

In the staking method described above, the surveying device is a total station which can measure an angle and a distance to a target. The difference measurement step includes placing the target at the predetermined point on the crossbeam to calculate a coordinate of the predetermined point.

In the staking method described above, the search step includes notifying by using a notification unit, once the height difference becomes zero.

In order to achieve the objective, a staking system according to the present disclosure includes: a surveying unit configured to measure a coordinate of a predetermined point on a crossbeam of a staking tool; a coordinate calculation unit configured to calculate a height difference between the coordinate of the predetermined point on the crossbeam and a plane including a designed slope; and a display unit configured to display the height difference calculated by the coordinate calculation unit.

### Advantage of the Invention

The present disclosure using the means described above increases the efficiency in placing a slope staking tool.

### BRIEF DESCRIPTION OF THE DRAWINGS

FIG. 1 shows a general configuration of an entire staking system according to an embodiment of the present disclosure.

FIG. 2 is a flowchart showing procedures of a staking method according to the embodiment.

FIG. 3A is a configuration diagram of a slope staking tool in steps S1 and S2 in FIG. 2.

FIG. 3B is a configuration diagram of the slope staking tool in a step S3 in FIG. 2.

FIG. 3C is a configuration diagram of the slope staking tool in steps S4 to S6 in FIG. 2.

FIG. 3D is a configuration diagram of the slope staking tool in a step S7 in FIG. 2.

### DESCRIPTION OF EMBODIMENT

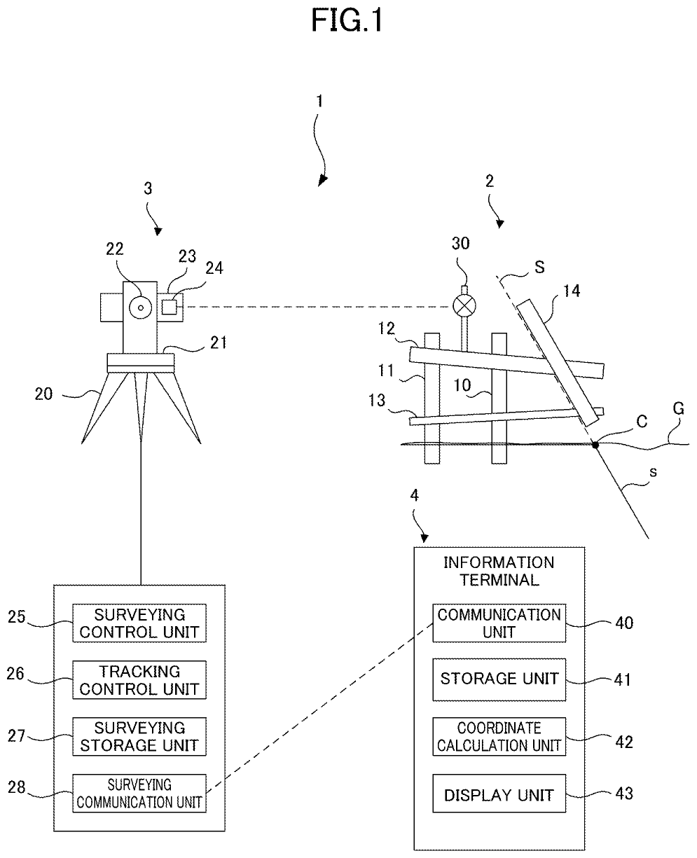

An embodiment of the present disclosure will be described below with reference to the drawings. FIG. 1 shows a configuration of a staking system according to the embodiment of the present disclosure.

As shown in FIG. 1, a staking system 1 according to this embodiment includes a slope staking tool 2, a surveying device (or a surveying unit) 3, and an information terminal 4.

The slope staking tool 2 mainly includes a first picket 10, a second picket 11, a first crossbeam 12, a second crossbeam 13, and a slope beam 14.

The first and second pickets 10 and 11 are plate-like or column-like woods erected near an intersection C between a current ground G and a plane S including a designed slope s. The first picket 10 is closer to the intersection C than the second picket 11 is.

Each of the first and second crossbeams 12 and 13 is a plate-like or column-like wood intersecting the first and second pickets 10 and 11 and extending across the first and second pickets 10 and 11. Note that the first crossbeam 12 is located above and the second crossbeam 13 is located below.

The slope beam 14 is a plate-like or column-like wood extending across the first and second crossbeams 12 and 13, on the plane S including the designed slope s. Specifically, the slope beam 14 is placed such that its lower surface extending longitudinally is positioned on the extension of the designed slope s.

Note that these first picket 10, second picket 11, first crossbeam 12, second crossbeam 13, and slope beam 14 may not have a uniform size.

The surveying device 3 is a total station placed on known position coordinates and can automatically tracks a prism 30 as a target to measure a predetermined point of the target. The surveying device 3 includes a horizontal rotation driving unit 21 supported by a tripod 20 and can perform horizontal rotation driving and a telescope unit 23 on the horizontal rotation driving unit 21 via a vertical rotation driving unit 22 which is vertically rotatable. Although not shown, the horizontal rotation driving unit 21 includes a horizontal angle detection unit that detects a horizontal rotation angle. The vertical rotation driving unit 22 includes a vertical angle detection unit that detects a vertical rotation angle. These horizontal and vertical angle detection units make it possible to perform measurement of the horizontal and vertical angles relative to the collimation direction of the telescope unit 23, respectively. The telescope unit 23 includes a distance measurement unit 24, such as an electro-optical distance meter, which measures a slope distance to the prism 30, for example. Although not shown, the telescope unit 23 includes a tracking unit which can emit and receive tracking light.

The surveying device 3 further includes a surveying control unit 25, a tracking control unit 26, a surveying storage unit 27, and a surveying communication unit 28.

The surveying control unit 25 functions to control the surveying by the surveying device 3. Specifically, the surveying control unit 25 automatically or manually collimates the prism 30, and detects the horizontal angle, the vertical angle, and the slope distance by using the horizontal and vertical angle detection units and the distance measurement unit 24 as described above. Here, the prism 30 is attached to a pole 31. The distance from the prism 30 to the tip of the pole 31 is known. The surveying control unit 25 thus corrects the horizontal angle, vertical angle, and slope distance detected by the horizontal and vertical angle measurement units and the distance measurement unit 24, and obtains the position of the tip of the pole 31, as surveying results.

The tracking control unit 26 controls the horizontal and vertical rotation driving units 21 and 22 to emit the tracking light by using the tracking unit and to continuously receive the tracking light reflected by the prism 30, thereby tracking the prism 30.

The surveying storage unit 27 stores, in advance, various programs for the surveying, tracking, or other controls; or data (e.g., the altitude) on the ground to be cut or banked, design data, or other data. Examples of the design data include here information on the cross-section of the cut or banked ground, such as the gradient of a designed slope obtained by cutting or banking, an inclination length (also referred to as a “slope length”), the coordinates of an upper end (also referred to as a “top of a slope” or a “top of a slope obtained by cutting”) of the designed slope, and the coordinates of a lower end (also referred to as a “toe of a slope” or a “toe of a slope obtained by banking”) of the designed slope. The surveying storage unit 27 can store results (e.g., the horizontal angle, the vertical angle, and the slope distance to the tip of the pole 31) of surveying by the surveying device 3.

The surveying communication unit 28 is communicative with external devices such as the information terminal 4 and is a wireless communication means, for example.

The information terminal 4 is, for example, a portable terminal, such as a tablet or a smartphone, or a personal computer that includes a communication unit 40, a storage unit 41, a coordinate calculation unit 42, and a display unit 43.

The communication unit 40 is communicative with the surveying communication unit 28 of the surveying device 3, and can receive the results (e.g., the horizontal angle, the vertical angle, and the slope distance to the tip of the pole 31) of surveying the prism 30 by using the surveying device 3.

The storage unit 41 can store the surveying results received by the communication unit 40. In addition, the storage unit 41 stores data on (e.g., the altitude of) a ground obtained by cutting or banking, design data, or other data.

The coordinate calculation unit 42 can calculate, from the surveying results stored in the storage unit 41, the coordinates of the tip of the pole 31 on the design data. The coordinate calculation unit 42 also calculates a height difference Δh between the tip of the pole 31 and the plane S including the designed slope s. Specifically, the coordinate calculation unit 42 calculates the coordinates of the intersection between a vertical line extending from the tip of the pole 31 and the plane S including the designed slope s to set, as the height difference Δh, the difference between the coordinates of the intersection and the tip of the pole 31.

The display unit 43 is a display which can, for example, display information such as results (i.e., the coordinates of the tip of the pole 31) and/or the height difference Δh calculated by the coordinate calculation unit 42. Although not shown, the information terminal 4 may include a speaker which emits sound for notification to an operator in addition to the display by the display unit 43.

The staking system 1 with such a configuration allows the placement of the slope staking tool 2, while checking the results of surveying the prism by the surveying device 3 using the information terminal 4.

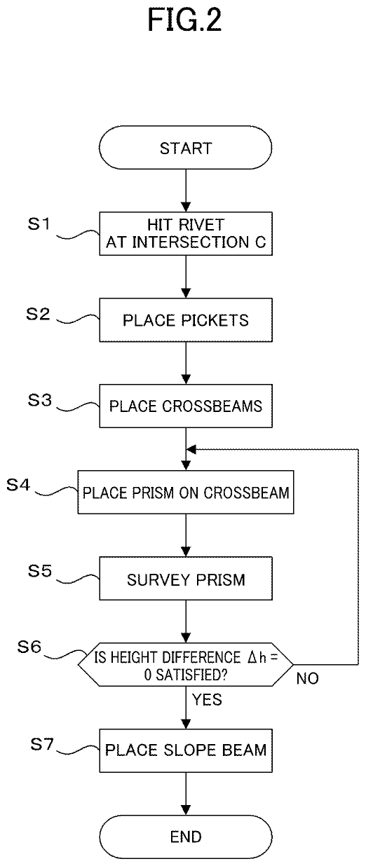

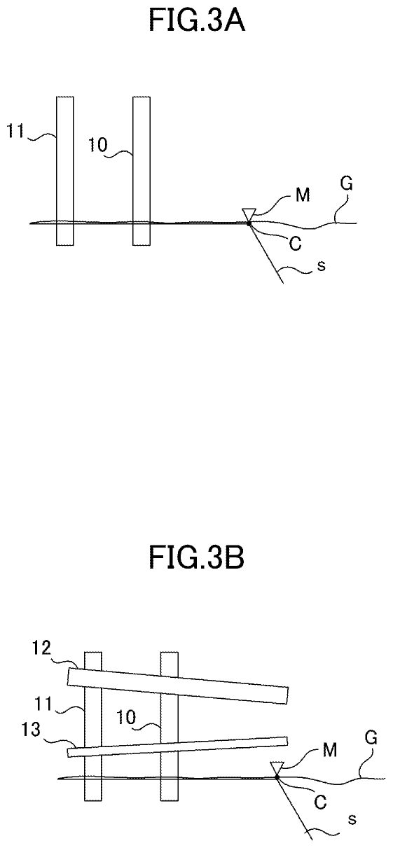

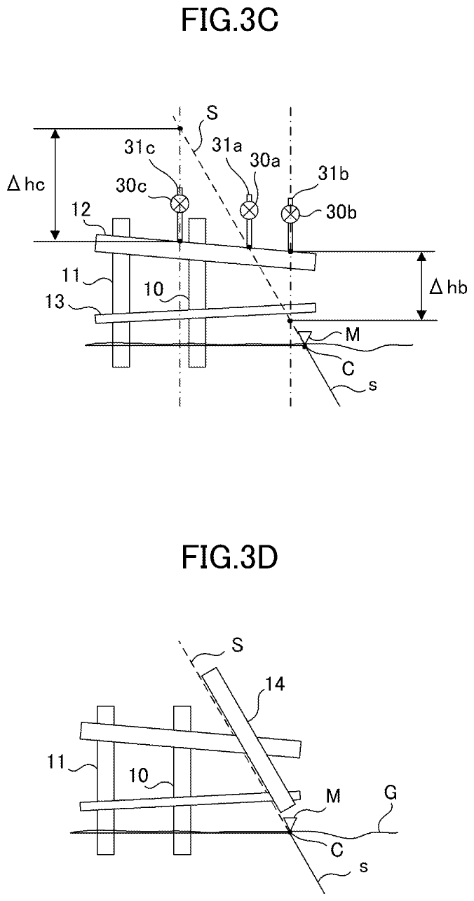

Specifically, FIG. 2 is a flowchart showing procedures of a staking method according to this embodiment. FIGS. 3A to 3D are configuration diagrams of the slope staking tool according to the steps in FIG. 2. Now, the staking method according to this embodiment will be described along the flowchart of FIG. 2 with reference to FIGS. 3A to 3D. An example where the slope staking tool 2 is placed on the top of a slope obtained by cutting will be described here.

First, in step S1, as shown in FIG. 3A, an operator uses the surveying device 3 and the prism 30 to search for the intersection C between the current ground G and the plane S including the designed slope s, and hits a rivet 15 as a mark at the intersection C.

In a subsequent step S2, the operator places the first and second pickets 10 and 11 near the intersection C (“picket placement step”). At this time, there is no need to place the first and second pickets 10 and 11 perpendicularly to the current ground.

In step S3, as shown in FIG. 3B, the operator places the first and second crossbeams 12 and 13 across the first and second pickets 10 and 11 (“crossbeam placement step”). At this time, the first and second crossbeams 12 and 13 may extend across the first and second pickets 10 and 11 and may not be necessarily placed horizontally.

In step S4, as shown in FIG. 3C, the operator places the prism 30 on the first crossbeam. Specifically, the tip of the pole 31 attached with the prism 30 abuts on the upper surface of the first crossbeam 12.

In step S5, the surveying device 3 surveys the prism 30 on the first crossbeam 12. The results of surveying are stored in the surveying storage unit 27 and transmitted via the surveying communication unit 28 and the communication unit 40 to the information terminal 4 so that the coordinate calculation unit 42 calculates the coordinates of the tip of the pole 31.

In a subsequent step S6, the coordinate calculation unit 42 of the information terminal 4 also calculates the height difference Δh between the tip of the pole 31 and the plane S including the designed slope s. The coordinate calculation unit 42 determines whether the height difference Δh is zero. Here, whether the height difference Δh is zero may be determined by the operator viewing the numerical value of the height difference Δh displayed on the display unit 43 of the information terminal 4, or may be notified by the display unit 43 or the speaker of the information terminal 4 once the coordinate calculation unit 42 determines that the height difference Δh is zero.

If the result of the determination in step S6 is false (No), the process returns to step S4 to place the prism 30 at a point different from the previous point on the first crossbeam 12 and steps S5 and S6 are then repeated. That is, until finding the point where the height difference Δh is zero, steps S4 to S6 are repeated to search for the point (“search step”).

For example, FIG. 3C shows a case of checking three points on the first crossbeam 12. The height difference Δh is zero at the tip of a pole 31a attached with a central prism 30a. A prism 30b, which is closer to the distal end of the first crossbeam 12 than the point (i.e., the tip of the pole 31a), has a pole 31b with a height difference Δhb indicating a vertical point higher than the plane S including the designed slope s. A prism 30c, which is closer to the proximal end of the first crossbeam 12, has a pole 31c with a height difference Δhc indicating a vertical point lower than the plane S including the designed slope s.

If the result of the determination in step S6 is true (Yes), that is, if the point is found where the height difference Δh is zero on the first crossbeam 12, the process proceeds to the next step S7.

In the step S7, the operator places the slope beam 14 across the first and second crossbeams 12 and 13 from the point where the height difference Δh is zero toward the intersection C (“slope beam placement step”).

As described above, in the staking method and the staking system according to this embodiment, there is no particular need to place the first and second pickets 10 and 11 and the first and second crossbeams 12, and 13 vertically or horizontally to place the slope staking tool 2. The placement position of the slope beam 14 can be determined only by searching for the point where the height difference Δh is zero between the first crossbeam 12 and the plane S including the designed slope s.

With the use of the surveying device 3 which can survey a prism, the point on the first crossbeam 12, on which the pole 31 attached with the prism 30 abuts, is changed to easily find the point where the height difference Δh is zero.

In step S6, upon determination that the height difference Δh is zero, the notification unit, such as the display unit 43 or the speaker of the information terminal 4, notifies the operator of the fact. Accordingly, the operator easily knows the point where the height difference Δh is zero, while changing the placement position of the prism 30.

The staking system 1 according to this embodiment includes: the surveying device 3 which can survey the coordinates of the predetermined point on the first crossbeam 12 of the slope staking tool 2; the coordinate calculation unit 42 configured to calculate the height difference Δh between the coordinate of the predetermined point on the first crossbeam 12 and the plane S including the designed slope s by using the information terminal 4; and the display unit 43 configured to display this height difference Δh. The staking system 1 implements the staking method described above so that an operator easily places the slope staking tool 2.

As described above, the staking method and staking system according to the present disclosure increase the efficiency in placing a slope staking tool.

The embodiment of the present disclosure has been described above, but the aspects of the present disclosure are not limited to the embodiment.

An example has been described above in the embodiment where the slope staking tool 2 is placed on the top of a slope obtained by cutting. The present disclosure is also applicable to a case where the slope staking tool 2 is placed on the toe of a slope obtained by banking.

In the embodiment described above, the surveying device 3 is a total station which can survey a prism. The surveying device is not limited thereto. For example, instead of a prism, a global navigation satellite system (GNSS) such as a global positioning system (GPS) may be used to measure the coordinate on a crossbeam.

The slope staking tool 2 according to the embodiment described above includes one pair of pickets (i.e., the first and second pickets 10 and 11) and one pair of crossbeams (i.e., the first and second crossbeams 12 and 13). The numbers of the pickets and crossbeams are however not limited thereto. For example, only one crossbeam may be used.

In the embodiment described above, the prism 30 is a target of the surveying device 3, but another retro-reflector may be used as a target.

### DESCRIPTION OF REFERENCE CHARACTERS

1 Staking System
2 Slope Stake
3 Surveying Device (Surveying Unit)
4 Information Terminal
10 First Picket
11 Second Picket
12 First Crossbeam
13 Second Crossbeam
14 Slope Beam
20 Tripod
21 Horizontal Rotation Driving Unit
22 Vertical Rotation Driving Unit
23 Telescope Unit
24 Distance Measurement Unit
25 Surveying Control Unit
26 Tracking Control Unit
27 Surveying Storage Unit
28 Surveying Communication Unit
30 Prism
31 Pole
40 Communication Unit
41 Storage Unit
42 Coordinate Calculation Unit
43 Display Unit
C Intersection
G Current Ground
s Designed Slope
S Plane Including Designed Slope
M Rivet

1. A staking method of placing a slope staking tool including a picket, a crossbeam, and a slope beam, the staking method comprising:
a picket placement step of placing the picket near an intersection between a current ground and a plane including a designed slope;
a crossbeam placement step of placing the crossbeam, on the picket placed so as to cross the picket;
a search step of searching for a point where a height difference between a predetermined point on the crossbeam and the plane including the designed slope is zero, the height difference being calculated by a surveying device; and
a slope beam placement step of placing, on the crossbeam, the slope beam inclined from the point where the height difference is zero as found in the search step, toward the intersection between the current ground and the plane including the designed slope.

2. The staking method of claim 1, wherein
the surveying device is a total station is configured to measure an angle and a distance to a target, and
the search step further includes placing the target at the predetermined point on the crossbeam to calculate a coordinate of the predetermined point.

3. The staking method of claim 1, wherein
the search step includes notifying by using a notification unit, once the height difference becomes zero.

4. A staking system comprising:
a surveying unit configured to measure a coordinate of a predetermined point on a crossbeam of a staking tool;
a coordinate calculation unit configured to calculate a height difference between the coordinate of the predetermined point on the crossbeam and a plane including a designed slope; and
a display unit configured to display the height difference calculated by the coordinate calculation unit.
